(19) United States
(12) Patent Application Publication
(10) Pub. No.: US 2008/0039747 A1
(43) Pub. Date: Feb. 14, 2008

(54) Device for Therapeutic Treatment of Foot, Heel, and/or Like Pain

(76) Inventors: Kevin Baerwalde, Doraville, GA (US); Becky Ivey, LaGrange, GA (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 11/672,567

(22) Filed: Feb. 8, 2007

Related U.S. Application Data
(63) Continuation of application No. 10/686,313, filed on Oct. 15, 2003, now abandoned.
(60) Provisional application No. 60/419,137, filed on Oct. 17, 2002.

(51) Int. Cl. A61H 1/00

(52) U.S. Cl. 601/15

(57) ABSTRACT

A therapeutic device having a relatively stiff and/or inflexible outer shell with a substantially ellipsoid shape, a plurality of protuberances extending outwardly from the outer shell, and a central core that is completely or substantially filled with a substance capable of being cooled or heated, such substance also capable of retaining cold or heat for an extended period of time.

### CROSS-REFERENCE TO RELATED APPLICATION

This application is a continuation of patent application Ser. No. 10/686,313, filed Oct. 15, 2003, which claims the benefit of priority of U.S. provisional application No. 60/419,137, filed Oct. 17, 2002, which are relied on and incorporated herein by reference.

### BACKGROUND OF THE INVENTION

The present invention relates generally to a device for use in relieving pain in the foot, heel, or any other soft tissue area on the body. In particular, the present invention relates to a device which provides hot and cold massage therapy to areas of the body in order to alleviate pain resulting from, and speed the healing of, myofascitis, plantar fasciitis, and/or any other soft tissue inflammation, tightness or contracture.

It is well known in the medical field that massage therapy, when combined with both hot and cold treatment, provides effective relief of pain associated with injured or sore muscles and speeds the healing process. Massage therapy is highly beneficial because it relaxes and stretches tight muscles, improves circulation, increases range of motion, frees trapped nerves, and relieves muscle spasm. The incorporation of cold treatment, if applied directly to the site of acute discomfort, causes the blood vessels to constrict, thereby decreasing blood flow to the injured area which, in turn, reduces pain. When used on soft tissue injuries, cold treatment penetrates deep into the tissues and reduces the inflammatory effects on soft tissue, bone and in joints, resulting in decreased swelling. Furthermore, the use of heat is generally introduced during the healing or rehabilitation stages of an injury. Heat therapy causes blood vessels to dilate, thereby increasing blood and oxygen flow to damaged tissue. This increased circulation allows cells to absorb nutrients and discharge metabolic waste products; in this way, heat therapy assists the body's natural healing process. Thus, each type of therapy (massage, heat, and cold) provides necessary and important benefits. It is therefore most advantageous to treat soreness and injuries to soft tissue by using a device that is capable of providing all three methods of therapy.

One common injury for which the combined benefits of localized massage, heat, and cold are routinely sought is plantar fasciitis. Plantar fasciitis is the inflammation of the plantar fascia (fasciitis), the bowstring-like tissue stretching underneath the sole of the foot which attaches at the heel. The condition is caused by overstressing the plantar fascia through such means as a change or increase in activities, a sudden injury, spending too much time on one's feet, a lack of arch support in the shoe, being overweight, or a lack of flexibility in the calf muscles. The classic sign of plantar fasciitis is heel pain with the first steps out of bed in the morning, when the plantar fascia is stretched violently out of the natural contraction that occurs during a state of sleep. This pain may ease gradually throughout the day, only to return the next morning.

Plantar fasciitis is related to a condition known as “heel spur syndrome.” Heel spurs are deposits of calcium in the plantar fascia near its attachment to the heel that result from repetitive stresses and inflammation in the plantar fascia. A heel spur may trap or irritate nerves in the heel, causing more pain and discomfort. Although plantar fasciitis and heel spur syndrome are two different conditions, it is usually unnecessary to distinguish between them because their causes and treatments are generally the same.

Those who suffer heel pain due to plantar fasciitis and/or heel spurs commonly seek treatment through physical therapy, corticosteroid drugs, surgical procedures, and a myriad of devices, cushions, and gels. Although less successful, non-surgical treatments are generally favored over surgical procedures due to the higher cost, invasiveness, and risk associated with operative intervention. Accordingly, it is well known in the art to provide devices that deliver a massaging effect to the foot in order to relieve the symptoms of plantar fasciitis and heels spurs.

U.S. Pat. No. 1,481,038, for example, discloses a rollable foot massaging device which can be operated by the individual to knead and manipulate the plantar fascia and muscles of the foot. This and other similar devices, such as U.S. Pat. No. 4,191,178, make known the use of a plurality of protuberances, designed and positioned on the device as to alternately stretch and compress the skin, muscles, and tendons on the underside of the foot. Such devices are advantageous because they are convenient, easy to manipulate, and relatively inexpensive. Their major shortcoming, however, is their inability to deliver either hot or cold treatment along with the massage therapy.

The dissatisfaction with the aforementioned devices gave rise to the use of apparatuses capable of combining some form of massage with either hot or cold treatment, but not both. For instance, U.S. Pat. No. 5,251,620 discloses a foot massager wherein the rollers may be removed, heated by such means as placing them in the oven, and then placed back into the massaging unit whereby they may deliver heat therapy to the foot. U.S. Pat. No. 3,977,202, on the other hand, proposes a cold pack device consisting of chemicals contained in separate compartments which, when combined, result in a chemical reaction and produce cold by the absorption of heat from the surroundings. This device may be used to apply cold treatment to the site of an injury, but is incapable of providing heat therapy.

Recent improvements in the art have been aimed at creating rollable massaging devices having a hollow cylindrical interior which may be filled with either a hot or a cold substance, such as water, thereby combining massage therapy with heat and cold treatment. U.S. Pat. No. 5,131,383, in particular, discloses a foot massage device with a hollow, elongated, tubular body whose left end has a removable plug or cap so that either hot or cold fluid may be placed inside. Similarly, U.S. Pat. No. 6,129,687 describes a device having two hollow, cylindrical containers so that one may be filled with hot liquid and the other filled with cold liquid to deliver both hot and cold therapy simultaneously.

These and similar devices are useful because they incorporate all three methods of treatment (massage, hot, and cold therapy), but nonetheless suffer from significant drawbacks. Namely, the acts required to convert these types of devices from one kind of therapy to another are troublesome and inconvenient. Adding liquid to a device tends to be messy and care must be taken to prevent the liquid from spilling during use. In addition, the liquid inside the device will necessarily slosh around as the device turns, resulting in an unsteady and awkward rolling motion during treatment. Furthermore, because the liquid inside the device quickly conforms to the ambient temperature, the hot or cold therapy cannot be sustained for a satisfactory length of time.

Still another shortcoming of the devices described above, is that their shape fails to properly conform to the underside of the foot. With reference to a foot's width, because the interior tissue is softer than the exterior, the interior tissue rises with respect to the exterior tissue as pressure is applied. A preferred device would accommodate this fact and distribute treatment evenly across the width of the underside of the foot.

A need therefore exists for an improved therapeutic device that is capable of providing massage, hot, and cold therapy in a simple and convenient manner that is inexpensive, easy to manufacture, and shaped appropriately to conform to the body.

### SUMMARY OF THE INVENTION

The present invention answers this need by providing a therapeutic device having a relatively stiff and/or inflexible outer shell with a substantially ellipsoid shape, a plurality of protuberances extending outwardly from the outer shell, and a central core that is completely or substantially filled with a substance capable of being cooled or heated, such substance also capable of retaining cold or heat for an extended period of time.

Generally described, the present invention relates to a therapeutic device, including an outer shell, a plurality of protuberances, and a central core. The outer shell has a substantially ellipsoid shape. The central core is completely or substantially filled with a substance. The substance inside the central core may be chilled by placing the device in a refrigerator, freezer, cold water bath, or by any other suitable method. Alternatively, the substance inside the central core may be heated by placing the device in a microwave oven, conventional oven, hot water bath, or by any other suitable means. To this end, the substance inside the central core advantageously transfers heat or cold to the exterior of the outer shell of the device at a controlled rate. Once chilled or heated, the user may employ his or her foot to roll the device back and forth upon the floor or other surface, whereby the protuberances manipulate the underlying plantar muscles with a kneading action and deliver the cold or heat directly to the site of soreness or injury. Due to the outer shell's substantially ellipsoid shape, the present invention delivers treatment evenly across the width of the underside of the foot by accommodating the rising of the softer interior surface of the foot bottom when pressure is applied.

It is thus an object of the present invention to provide a therapeutic device that combines massage therapy with convenient delivery of hot and cold treatment in order to relieve the symptoms of plantar fasciitis, heel spurs, and/or any other soft tissue inflammation.

Another object of the present invention is to provide a therapeutic device that is properly shaped such that it conforms to the body part being treated.

It is a further object of the present invention is to provide a therapeutic device that is inexpensive, durable, light-weight, and portable.

Another object of the present invention is to provide a therapeutic device that may be used by an individual without the assistance of a trained physiotherapist.

Still another object of the present invention is to provide a therapeutic device that is inexpensive and easy to manufacture.

Other objects, features, and advantages of the present invention will become apparent upon inspection of the following detailed description of the preferred embodiment of the invention, taken in conjunction with the drawings and appended claims.

### BRIEF DESCRIPTION OF THE DRAWINGS

FIG. 1 is a cross-sectional view of an outer shell of a therapeutic device in an embodiment of the present invention.

FIG. 2 is a cross-sectional view of the outer shell as illustrated in FIG. 1, with a series of protuberances extending outwardly from said outer shell.

FIG. 3 is a perspective view of an embodiment of the present invention in the shape of a sphere.

FIG. 4 is a perspective view of an embodiment of the present invention in the shape of a oval.

FIG. 5 is a perspective view of an embodiment of the present invention in the shape of a cylinder.

### DETAILED DESCRIPTION OF THE INVENTION

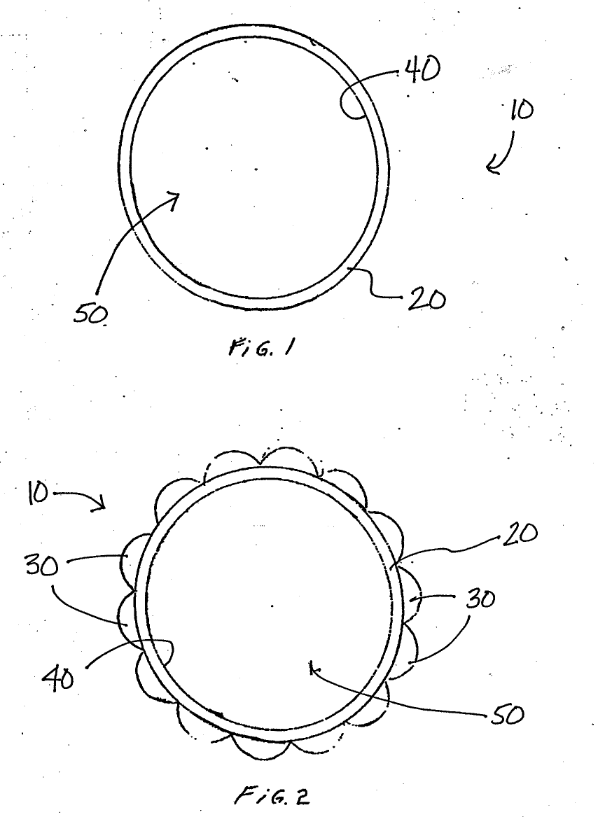

Referring to FIGS. 1 and 2, the present invention provides a therapeutic device 10 for use in relieving pain in the foot, heel, or any other soft tissue area on the body. The therapeutic device 10 includes a substantially ellipsoid outer shell 20, a plurality of protuberances 30 extending outwardly from the outer shell 20, and a central core 40. The central core 40 is substantially filled with a substance 50.

The outer shell 20 is preferably constructed from molded or thermoformed plastic such as polypropylene, polyethylene, acrylonitrile butadiene styrene (ABS), polystyrene, polyvinyl chloride (PVC), or high impact polystyrene (HIPS). Advantageously, the outer shell 20 is formed using an injection blow molding tool. In alternative embodiments steel, aluminum, wood, metals and other non-plastic materials and plastic/non-plastic composites may also be injection molded. Those of ordinary skill in the art will appreciate that the invention encompasses virtually any material and composites capable of injection molding depending on the desired characteristics of the formed article.

A typical outer shell 20 manufactured according to this embodiment is ellipsoid in shape with a major axis (i.e., length) of approximately three (3) to eight (8) inches, and semi-major and minor axes (i.e., height) of approximately two (2) to six (6) inches. It will be appreciated that all dimensions will vary according to the end-use and desired characteristics of the outer shell 20.

The plurality of protuberances 30 are preferably constructed of the same or similar materials as the outer shell 20, are formed along the exterior surface of the outer shell 20, and may be formed when the outer shell 20 is formed, or after the outer shell 20 is formed. The plurality of protuberances 30 are formed in a random pattern or in a predetermined pattern of annular rows and are spaced from about 0.75 to about 1.0 inches apart along the major axis, or length, of the outer shell 20. The plurality of protuberances 30 are advantageously less than about 0.25 inches in diameter, and from about 0.05 to about 0.25 inches in height. In the preferred embodiment, the plurality of protuberances 30 are formed in annular rows which are staggered so as not to be longitudinally aligned, such rows being spaced approximately 0.2 inches apart, and each protuberance 30 having a height of approximately 0.075 inches.

During construction of the outer shell 20, the central core 40 is substantially filled with a substance 50. Advantageously, the substance 50 is a glycol, more advantageously propylene or ethylene glycol. Alternatively, the substance 50 may be TEMTRO™ Dry Gel or TEMTRO™ SGP (Soft Gel Pack) Additive, two materials which can be heated or cooled and will thereafter retain such heat or cold for an extended period of time.

In use, if cold therapy is desired, the therapeutic device 10 may be placed in a refrigerator, freezer, cold water bath, or cooled by any other suitable method, thereby cooling the substance 50 within the central core 40. The substance 50 transfers this coldness to the exterior of the outer shell 20 at a controlled rate. The user may then employ his or her foot to roll the therapeutic device 10 back and forth upon the floor or other surface, whereby the plurality of protuberances 30 manipulate the underlying plantar muscles with a kneading action and deliver the cold directly to the site of soreness or injury. Due to the outer shell's 20 substantially ellipsoid shape, the therapeutic device 10 delivers treatment evenly across the width of the underside of the foot by accommodating the rising of the softer interior surface of the foot bottom when pressure is applied.

Alternatively, if heat treatment is desired, the therapeutic device 10 may be placed in a microwave oven, conventional oven, hot water bath, or heated by any other suitable method, thereby heating the substance 50 within the central core 40. The substance 50 transfers this heat to the exterior of the outer shell 20 at a controlled rate. The user may then employ his or her foot in the manner previously described to deliver the heat directly to the site of soreness or injury.

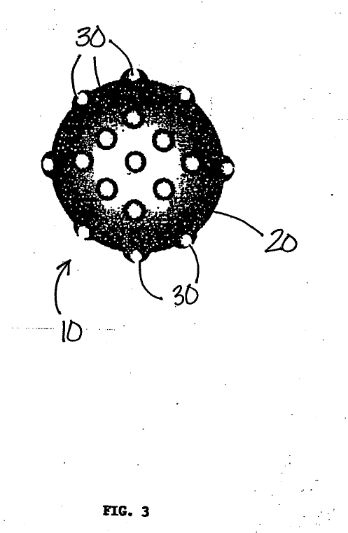

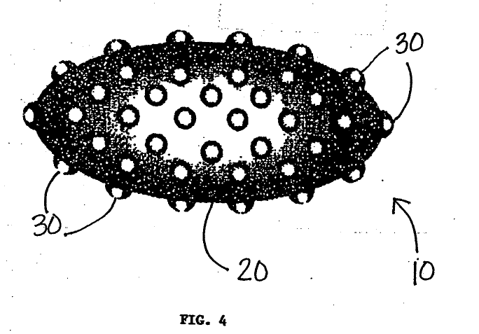

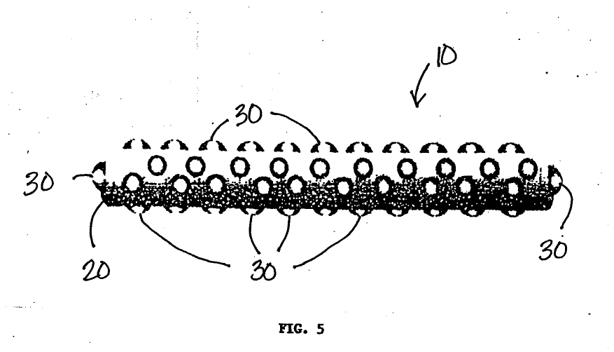

It will be appreciated that the therapeutic device 10 may be used in a similar fashion to deliver massage, heat and cold therapy to other parts of the body. The therapeutic device 10 may also include an embodiment having two or more cavities having the ability for each cavity to be filled with the same or differing substances. To this end, FIGS. 3 and 4 depict alternative embodiments of the present invention which incorporate handles 60a, 60b, and 65 to aid in manipulating the therapeutic device 10.

In FIG. 3, two solid, cylindrical handles 60a and 60b are attached to the outer shell 20 at each end along its major, longitudinal, axis. During treatment, the user may grasp the therapeutic device 10 by the handles 60a and 60b and roll the device 10 along the surface of the neck, back, calf, or other body part, thereby applying pressure to the site of soreness and advantageously delivering massage and hot or cold therapy.

FIG. 4 shows an alternative embodiment in which a solid, T-shaped handle 65 is attached to the outer shell 20 along its minor axis. In a manner comparable to that described above, the user may grasp the therapeutic device 10 by the handle 65 and advantageously deliver massage and hot or cold therapy to the neck, back, calf, or other site of soreness or injury.

The handles 60a, 60b, and 65 are preferably constructed of a material similar to that of the outer shell 20 and are fixedly or rotatably attached to the outer shell 20. Although embodiments of the therapeutic device 10 consistent with FIGS. 3 and 4 are particularly useful in aiding manipulation of the device 10, other handle designs may be adequate to achieve the desired results. For example, while the handles 60a, 60b, and 65 are constructed of a material similar to that of the outer shell 20 and composed of solid, cylindrical forms, they need not be so constructed or shaped. Also, other methods of joinder for the handles 60a, 60b, and 65 and the outer shell 20 may be used, including adhesives, mechanical fasteners, welding, Emabond, stapling, hot staking or other conventional means.

Although this invention has been described in specific detail with reference to the disclosed embodiments, it will be understood that many variations and modifications may be affected within the spirit and scope of the invention as described in the following claims.

1. A therapeutic device comprising:
a. an outer shell;
b. a plurality of protuberances extending outwardly from said outer shell; and
c. a central core;
wherein said central core is substantially filled with a substance, said substance permanently sealed within said central core; and
wherein said outer shell is substantially ellipsoid.

2. The device of claim 1, wherein said substance is capable of being cooled and/or heated.

3. The device of claim 1, wherein said outer shell comprises a plastic material.

4. The device of claim 1, wherein said outer shell comprises a composite material.

5. The device of claim 1, wherein said outer shell includes at least one material selected from the group consisting of plastic, wood and metal.

6. The device of claim 1, wherein said substance comprises a glycol.

7. The device of claim 1, wherein said substance includes at least one material selected from the group consisting of propylene glycol, ethylene glycol, TEMTRO™ Dry Gel and TEMTRO™ SGP (Soft Gel Pack) Additive.

8. The device of claim 1, wherein said plurality of protuberances substantially surround said outer shell.
